(19) United States
(12) Patent Application Publication
(10) Pub. No.: US 2008/0184913 A1
(43) Pub. Date: Aug. 7, 2008

(54) Bitumen or asphalt compositions stabilized against weathering

(76) Inventor: Jose A. Luna y Santos, Puebla (MX)

Correspondence Address: JoAnn Villamizar;Ciba Corporation/Patent Department, 540 White Plains Road, P.O. Box 2005, Tarrytown, NY, 10591, US

(21) Appl. No.: 11/986,731

(22) Filed: Nov. 26, 2007

Related U.S. Application Data
(60) Provisional application No. 60/861,192, filed on Nov. 27, 2006.

(51) Int. Cl. C08L 95/00

(52) U.S. Cl. 106/284.4; 524/71

(57) ABSTRACT

Asphalt or bitumen compositions are effectively stabilized against the deleterious effects of heat, light and oxygen, via the incorporation therein of an effective stabilizing amount of one or more sterically hindered amine compounds. The sterically hindered amines are macrocyclic, thermally stable, insoluble in water and have very low vapor pressure. The sterically hindered amines are for instance the cyclic condenstates of N,N′-bis(2,2,6,6-tetramethyl-4-piperidyl)-hexamethylenediamine and 4-tert-octylamino-2,6-dichloro-1,3,5-triazine, of N,N′-bis(2,2,6,6-tetramethyl-4-piperidyl)-hexamethylenediamine and 4-cyclohexylamino-2,6-dichloro-1 ,3, 5-triazine, or of N,N′-bis-(2,2,6,6-tetramethyl-4-piperidyl)hexamethylenediamine and 4-morpholino-2,6-dichloro-1,3,5-triazine. Synthetic rubber modified asphalt or bitumen may also be stabilized via incorporation of these hindered amines. The hindered amines may be present in the asphalt or bitumen or the rubber, or may be present in each of the asphalt, bitumen and rubber.

This application claims priority of U.S. provisional app. No. 60/861,192, filed Nov. 27, 2006, which is incorporated by reference.

The present invention is aimed at the stabilization of bitumen or asphalt compositions against the deleterious effects of heat, light and oxygen.

### BACKGROUND

Bitumen and asphalt are well known materials employed for example in roads and roofing materials. As such, these compositions are exposed to ambient weather over long periods of time and suffer the deleterious effects of heat, light and oxygen. It is desirable that such compositions maintain their original properties over longer periods of time. Road asphalt pavement for example will lose its ductility and softness over time. The asphalt pavement then suffers failure in the form cracks, requiring expensive repair or maintainence.

U.S. Pat. No. 4,247,335 is aimed at paving-grade asphalt compositions having improved resistance to weathering.

U.S. Pat. No. 4,923,712 discloses an asphaltic flashing stick.

U.S. Pat. No. 4,912,155 teaches antioxidant aromatic fluorophosphites.

U.S. Pat. No. 6,306,976 is aimed at a rubbery polymer.

U.S. Pat. No. 6,174,940 teaches synergistic stabilizer mixtures.

U.S. Pat. No. 6,914,110 is aimed at a process for producing a polymer having crosslinkable silyl groups.

U.S. Pat. Nos. 4,442,250 and U.S. Pat. No. 7,122,663 disclose certain macrocyclic sterically hindered amine compounds.

There remains a need to stabilize asphalt and bitumen employed in outdoor conditions.

### SUMMARY

Disclosed are asphalt or bitumen compositions, stabilized against the deleterious effects of heat, light and oxygen, said compositions comprising

asphalt or bitumen and

incorporated therein, an effective stabilizing amount of one or more sterically hindered amine compounds of the formula I,

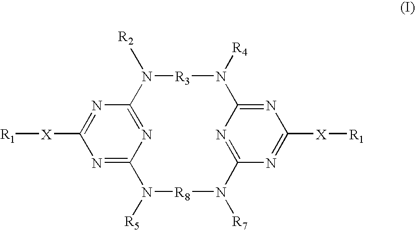

where

R₁ is hydrogen, C₁-C₁₈alkyl, C₃-C₁₈alkenyl, C₅-C₁₈cycloalkyl, C₆-C₁₈aryl, C₇-C₉aralkyl or —R₈—Y,

or R₁ is a group of formula II or III,

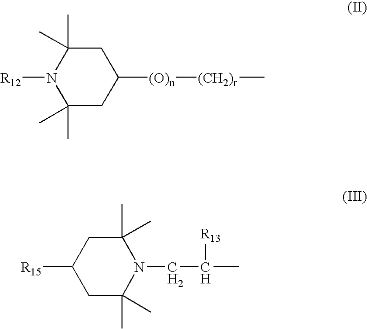

n is O or 1,

r is 0, 1, 2 or 3,

X is —O—, —S—, or >NR₁₆,

XR₁ as a whole may also be chlorine or morpholino, pyrrolidin-1-yl, piperidin-1-yl or hexahydroazepin-1-yl,

R₂, R₄, R₅ and R₇ independently are hydrogen, C₁-C₁₂alkyl, C₂-C₆hydroxyalkyl, C₃-C₁₂alkenyl, C₅-C₁₂cycloalkyl, C₆-C₁₈aryl, C7-C₉aralkyl or a group of formula II,

R₃ and R₆ independently are C₂-C₁₂alkylene, C₄-C₁₂iminodialkylene or oxadialkylene, C₅-C₁₂cycloalkylene, C₆-C₁₂arylene or C₇-C₁₂aralkylene,

R₈ is C₂-C₆alkylene,

Y is —O—R₉ or —NR₁₀R_{11,}

R₉ is hydrogen or C₁-C₁₈alkyl,

R₁₀ and R₁₁ are independently C₁-C₆alkyl, 2,2,6,6-tetramethylpiperid-4-yl or 1,2,2,6,6-pentamethylpiperid-4-yl,

R₁₂ is hydrogen, oxyl, C₁-C₁₂alkyl, C₃-C₁₂alkenyl, C₇-C₉aralkyl, C₁-C₁₂acyl, 2,3-epoxypropyl or —CH₂CH(R₁₃)O—R₁₄,

or R₁₂ is C₁-C₁₂alkoxy, C₂-C₁₂alkenyloxy, C₅-C₁₂cycloalkoxy, C₅-C₈cycloalkenyloxy, C₆-C₁₈aryloxy, C₇-C₉aralkyloxy,

or R₁₂ is 2-hydroxy-2-methyl-propoxy or 2-hydroxycyclohexyloxy,

R₁₃ is hydrogen, methyl, ethyl or phenyl,

R₁₄ is hydrogen, C₁-C₁₂alkyl, C₃-C₁₂alkenyl, C₇-C₉aralkyl or C₁-C₁₂acyl,

R₁₅ is hydrogen, C₁-C₈alkoxy, C₃-C₈alkenyloxy or benzyloxy and

R₁₆ is defined as for R₁,

with the proviso that at least one of the groups R₁, R₂, R₄, R₅ and R₇ is a group of formula II.

Also disclosed is a process for the stabilization of asphalt or bitumen against the deleterious effects of heat, light and oxygen, which process comprises

incorporating into asphalt or bitumen an effective stabilizing amount of one or more sterically hindered amine compounds of the formula I.

### DETAILED DISCLOSURE

The macrocyclic hindered amines of formula I are disclosed for example in U.S. Pat. Nos. 4,442,250 and U.S. Pat. No. 7,122,663, the disclosures of which are hereby incorporated by reference.

The compounds of formula I are for example the cyclic condensates of N,N′-bis(2,2,6,6-tetramethyl-4-piperidyl)-hexamethylenediamine and 4-tert-octylamino-2,6-dichloro-1,3,5-triazine, of N,N′-bis(2,2,6,6-tetramethyl-4-piperidyl)-hexamethylenediamine and 4-cyclohexylamino-2,6-dichloro-1,3,5-triazine, or of N, N′-bis-(2,2,6,6-tetramethyl-4-piperidyl)hexamethylenediamine and 4-morpholino-2,6-dichloro-1,3,5-triazine:

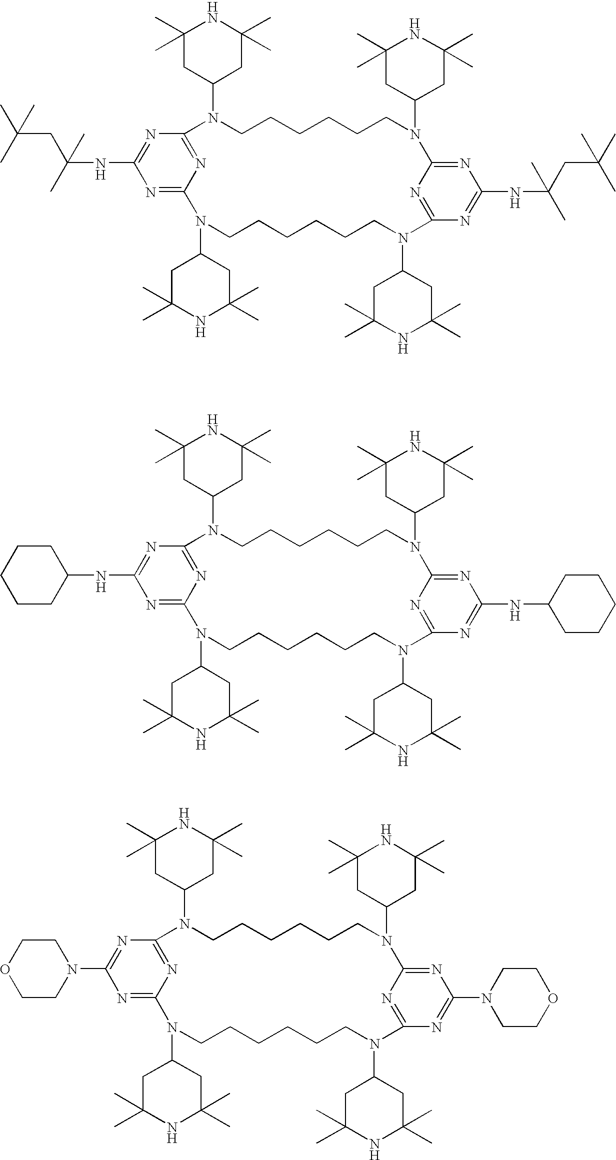

R₁₂ is for example hydrogen or methyl.

R₃ and R₆ are for example C₂-C₁₂alkylene.

X is for example —O— or >NR₁₆.

R₁₆ is for example hydrogen and R₁ is for example C₁-C₁₈alkyl.

R₁X is for example t-octylamino or morpholino.

The compounds of formula I may also be in the form of organic or inorganic acid salts. For example salts of the formula (I)·(HY)ₙ where HY is an organic or inorganic acid and n is an integer of 1 to 4.

For example HY is selected from the group consisting of a halogen containing inorganic protonic acid, a phosphorus containing inorganic acid, a sulfur containing inorganic acid, a C₁-C₄alkyl carboxylic acid, a perfluoro C₁-C₄alkyl carboxylic acid and an aromatic carboxylic acid.

The present hindered amine additives for example have melting points above about 320° C. The present hindered amine additives for example have molecular weights greater then or equal to about 1198 g/mol. Their cyclic structure provides for outstanding heat stability. The additives have very low vapor pressure; they are not lost by evaporation even at high temperatures. For example the vapor pressure is 4.1×10⁻¹⁴ Pa at 25° C. The additives are not water soluble. 1 Pa=1 N/m²=10⁻⁵ bar.

Alkyl is a branched or unbranched group and is for example methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3- tetramethylpentyl, nonyl, decyl, undecyl, 1-methylundecyl, dodecyl, or 1,1,3,3,5,5-hexamethylhexyl.

Alkenyl is an unsaturated version of alkyl, for example isopropenyl, propenyl, hexenyl, heptenyl, and the like.

Cycloalkyl is substituted or unsubstituted and is, for example, cyclopentyl, methyl-cyclopentyl, dimethylcyclopentyl, cyclohexyl, methylcyclohexyl, dimethylcyclohexyl, trimethyl-cyclohexyl, tert-butylcyclohexyl, cycloheptyl or cyclooctyl. For example cyclohexyl and tert-butylcyclohexyl.

Cycloalkylene is an unsaturated version of cycloalkyl.

Aryl is for example phenyl or naphthyl or biphenyl, but also comprised are C₁-C₄alkyl substituted phenyl, C₁-C₄alkoxy substituted phenyl, hydroxy, halogen or nitro substituted phenyl. Examples for alkyl substituted phenyl are ethylbenzene, toluene, xylene and its isomers, mesitylene or isopropylbenzene. Halogen substituted phenyl is for example dichlorobenzene or bromotoluene.

Aralkyl is for example phenylalkyl which is unsubstituted or substituted on the phenyl group by from 1 to 3 C₁-C₄alkyl groups and is, for example, benzyl, α-methylbenzyl, α,α-dimethylbenzyl, 2-phenylethyl, 2-methylbenzyl, 3-methylbenzyl, 4-methylbenzyl, 2,4-dimethylbenzyl, 2,6-dimethylbenzyl or 4-tert-butylbenzyl. For example benzyl.

Alkylene is a branched or unbranched group, for example methylene, ethylene, propylene, trimethylene, tetramethylene, pentamethylene, hexamethylene, heptamethylene, octamethylene, decamethylene or dodecamethylene.

Cycloalkylene is a saturated hydrocarbon group having two free valences and at least one ring unit and is, for example, cyclopentylene, cyclohexylene, cycloheptylene or cyclooctylene. For example cyclohexylene.

Arylene is phenylene or naphthylene or biphenylene, each unsubstituted or substituted by C₁-C₄alkyl, for example, 1,2-, 1,3- or 1,4-phenylene or 1,2-, 1,3-, 1,4-, 1,6-, 1,7-, 2,6- or 2,7-naphthylene. For instance 1,4-phenylene.

Aralkylene is for instance phenylalkylidene and is, for example, benzylidene, 2-phenyl-ethylidene or 1-phenyl-2-hexylidene.

Alkyl portions of alkoxy and hyroxyalkoxy and acyl are defined as for the alkyl groups above.

Cycloalkyl portions of cycloalkoxy are defined as for the cycloalkyl groups above.

Alkenyl portions of alkenyloxy are defined as for the alkenyl groups above.

Cycloalkenyl portions of cycloalkenyloxy are defined as for the cycloalkenyl groups above.

Aryl portions of aryloxy are defined as for the aryl groups above.

Aralkyl portions of aralkyloxy are defined as for the aralkyl groups above.

Bitumen or asphalt according to the present invention are for example disclosed in U.S. Pat. Nos. 4,247,335 and 5,473,000, the disclosures of which are hereby incorporated by reference.

Bitumen and asphalt are normally solid, semi-solid or viscous liquid materials at ordinary atmospheric temperatures. Such asphalts and bitumens are mixtures of hydrocarbons of natural or pyrogenous origin and are usually derived from petroleum or coal but may occur as such in nature.

Bitumen is a natural or technologically produced complex organic mixture of varying color and consistency, mainly composed of hydrocarbonaceous and/or organic oxygen compounds. By “bitumen” is specifically meant asphalts and petroleum distillation residues (asphaltic bitumen). Bitumens are mixtures of different types of materials, such as asphaltenes, resins, solid paraffins, kerosines, hydrocarbonaceous oils, ester waxes, kerogens, high-molecular acids and metalorganic compounds. Natural bitumens are obtained, for example, from natural gas, crude petroleum, natural asphalts, mineral wax (ozokerite), montan wax (brown carbon bitumen) and fossil resins. Man-made bitumens are obtained from petroleum distillates, solid paraffin, petroleum distillation residues, residues from the acid treatment of petroleum products and products of solvent and precipitant treatments of petroleum products. In the Unites States there are further defined so-called pyrobitumens, which are classified into asphaltic pyrobitumens (wurtzilite, elaterite, albertire and impsonite) and kerogenites (shales and limestones).

By “asphalt” is meant primarily conventional asphalt and emulsified asphalt, which is a bitumen product emulsified in water.

Also included within the definition of bitumen and asphalt are road oil and road tar.

The bitumen or asphalt according to this invention is in particular employed in road paving or in roofing materials. The present compositions based on bitumen or asphalt can be used, for example, as binders with mineral aggregates, fillers or fiber materials, in which case the working in general takes place by using melting. Compositions according to this invention may also be used for the impregnation of cardboard, papers or foils and for the coating of concrete, mortar or metal, in which case the working can take place at room temperature by using dissolving or dispersing. Bitumen may be of any commercial qualtity according to ASTM standards.

The hindered amine additives of the invention are incorporated by well known and convenient methods such as by stirring while the asphalt is heated and in a fluid state. Other additives such as anti-stripping agents may be incorporated along with the additives described herein.

Asphalt modified with synthetic rubber, employed for example for paving, is also included in this invention. Modified asphalt is disclosed for example in U.S. Pat. No. 5,473,000. Synthetic rubber is for example styrene-butadiene rubber.

It is also contemplated that the hindered amines are present as additives in the synthetic rubber portion of a modified asphalt, or present in both the asphalt and the rubber. The hindered amines may be incorporated into a synthetic rubber by known methods, for example melt extrusion, co-kneading and the like.

Thus, further aspects of this invention are modified asphalt or bitumen compositions, stabilized against the deleterious effects of heat, light and oxygen, said compositions comprising asphalt or bitumen,

a synthetic rubber and

incorporated in the asphalt, bitumen or rubber, or in each of the asphalt, bitumen and rubber, an effective stabilizing amount of one or more sterically hindered amine compounds of formula I.

The amount of hindered amine to be incorporated into the asphalt or bitumen is for example in the range of about 0.01% to about 7% by weight, based on the weight of the asphalt or bitumen. For instance, the present additives are present from about 0.05% to about 6% by weight, from about 0.1% to about 5% by weight, from about 0.25% to about 5% by weight, or from about 0.3% to about 5% by weight, based on the weight of the asphalt or bitumen. For instance, the hindered amines may be present at a level of about 0.5%, 1%, 2%, 3% or 4% by weight, based on the weight of the asphalt or bitumen.

The same weight levels may be employed in the synthetic rubber.

The advantageous effects of the present hindered amine additives towards the stabilization of asphalt or bitumen is observed by standard ASTM methods used to measure the properties thereof.

For instance, the stabilization of asphalt or bitumen is measured by penetration, softening point and ductility.

Penetration is measured according to ASTM D5. It involves the extent to which a standard needle penetrates a properly prepared sample of asphalt under definitely specified conditions of temperature, load and time. Soft asphalts have high penetration values.

Softening point is measured according to ASTM D36. The softening point of an asphalt may be defined as that temperature at which an asphalt attains a particular degree of softness under specified conditions of test. It is commonly used to classify industrial and roofing asphalt grades.

Ductility is measured according to ASTM D 113. The ductility of an asphalt is expressed as the distance in cm which a standard briquette can be elongated before breaking. Ductility is a combination of flow properties and reflects both cohesion and shear susceptibility.

For example, after a 7 year period of use, a common asphalt road will have had its penetration factor cut in half, will have had its softening point increased by about 30° C. and its ductility reduced by a factor of about 50.

Stabilization with the present additives greatly improves the performance of asphalt or bitumen as measured according to these methods.

The bitumen employed in the present Examples have a penetration of between 30 to 400 according to ASTM D5-25. For instance, the bitumen presently tested has a penetration of 85-100 at 77° F.

What is claimed is:

1. Asphalt or bitumen compositions, stabilized against the deleterious effects of heat, light and oxygen, said compositions comprising
asphalt or bitumen and
incorporated therein, an effective stabilizing amount of one or more sterically hindered amine compounds of the formula I, 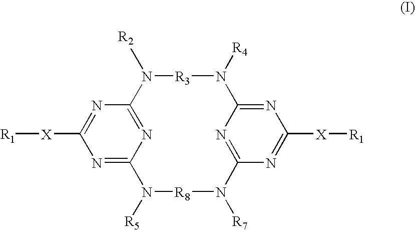
where
R₁ is hydrogen, C₁-C₁₈alkyl, C₃-C₁₈alkenyl, C₅-C₁₈cycloalkyl, C₆-C₁₈aryl, C₇-C₉aralkyl or —R₈—Y,
or R₁ is a group of formula II or III, 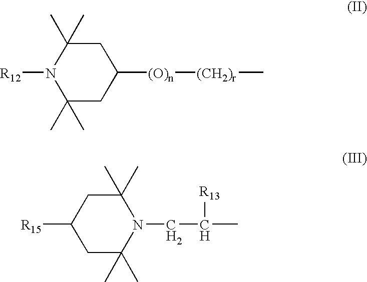
n is 0 or 1,
r is 0, 1, 2 or 3,
X is —O—, —S—, or >NR₁₆,
XR₁ as a whole may also be chlorine or morpholino, pyrrolidin-1-yl, piperidin-1-yl or hexahydroazepin-1-yl,
R₂, R₄, R₅ and R₇ independently are hydrogen, C₁-C₁₂alkyl, C₂-C₆hydroxyalkyl,
C₃-C₁₂alkenyl, C₅-C₁₂cycloalkyl, C₆-C₁₈aryl, C₇-C₉aralkyl or a group of formula II,
R₃ and R₆ independently are C₂-C₁₂alkylene, C₄-C₁₂iminodialkylene or oxadialkylene,
C₅-C₁₂cycloalkylene, C₆-C₁₂arylene or C₇-C₁₂aralkylene,
R₈ is C₂-C₆alkylene,
Y is —O—R₉ or —NR₁₀R₁₁,
R₉ is hydrogen or C₁-C₁₈alkyl,
R₁₀ and R₁₁ are independently C₁-C₆alkyl, 2,2,6,6-tetramethylpiperid-4-yl or 1,2,2,6,6-pentamethylpiperid-4-yl,
R₁₂ is hydrogen, oxyl, C₁-C₁₂alkyl, C₃-C₁₂alkenyl, C₇-C₉aralkyl, C₁-C₁₂acyl, 2,3-epoxypropyl or —CH₂CH(R₁₃)o—R₁₄, or R₁₂ is C₁-C₁₂alkoxy, C₂-C₁₂alkenyloxy, C₅-C₁₂cycloalkoxy, C₅-C₈cycloalkenyloxy, C₆-C₁₈aryloxy, C₇-C₉aralkyloxy,
or R₁₂ is 2-hydroxy-2-methyl-propoxy or 2-hydroxycyclohexyloxy,
R₁₃ is hydrogen, methyl, ethyl or phenyl,
R₁₄ is hydrogen, C₁-C₁₂alkyl, C₃-C₁₂alkenyl, C₇-C₉aralkyl or C₁-C₁₂acyl,
R₁₅ is hydrogen, C₁-C8alkoxy, C₃-C₈alkenyloxy or benzyloxy and
R₁₆ is defined as for R₁,
with the proviso that at least one of the groups R₁, R₂, R₄, R₅ and R₇ is a group of formula II.

2. A composition according to claim 1 where the compounds of formula I are the cyclic condenstates of N,N′-bis(2,2,6,6-tetramethyl-4-piperidyl)-hexamethylenediamine and 4-tert-octylamino-2,6-dichloro-1,3,5-triazine, of N, N′-bis(2,2,6,6-tetramethyl-4-piperidyl)-hexamethylenediamine and 4-cyclohexylamino-2,6-dichloro-1,3,5-triazine, or of N,N′-bis-(2,2,6,6-tetramethyl-4-piperidyl)hexamethylenediamine and 4-morpholino-2,6-dichloro-1,3,5-triazine.

3. A composition according to claim 1 where the compounds of formula I are the cyclic condensates of N,N′-bis(2,2,6,6-tetramethyl-4-piperidyl)-hexamethylenediamine and 4-tert-octylamino-2,6-dichloro-1,3,5-triazine.

4. A composition according to claim 1 where
R₃ and R₆ are C₂-C₁₂alkylene,
R₁₂ is hydrogen or methyl,
X is —o— Or >NR₁₆ and
R₁₆ is hydrogen and R₁ is C₁-C₁₈alkyl.

5. A composition according to claim 1 where
R₃ and R₆ are C₂-C₁₂alkylene,
R₁₂ is hydrogen or methyl,
R₁X is t-octylamino or morpholino.

6. A composition according to claim 1 where the hindered amine compounds of formula I are present from about 0.01% to about 7% by weight, based on the weight of the asphalt or bitumen.

7. A composition according to claim 1 where the hindered amine compounds of formula I are present from about 0.3% to about 5% by weight, based on the weight of the asphalt or bitumen.

8. A modified asphalt or bitumen composition, stabilized against the deleterious effects of heat, light and oxygen, said compositons comprising
asphalt or bitumen,
a synthetic rubber and
incorporated in the asphalt, bitumen or rubber, or in each of the asphalt, bitumen and rubber, an effective stabilizing amount of one or more sterically hindered amine compounds of formula I 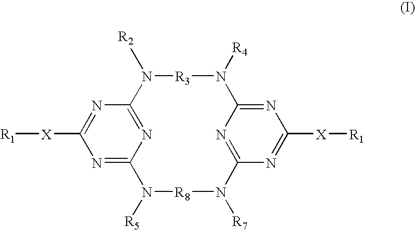
where
R₁ is hydrogen, C₁-C₁₈alkyl, C₃-C₁₈alkenyl, C₅-C₁₈cycloalkyl, C₆-C₁₈aryl, C₇-C₉aralkyl or —R₈—Y,
or R₁ is a group of formula II or III, 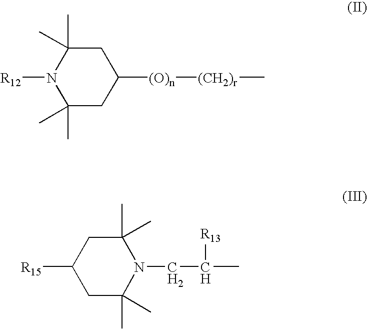
n is 0 or 1,
r is 0,1,2 or 3,
X is —O—, —S—, or >NR₁₆,
XR₁ as a whole may also be chlorine or morpholino, pyrrolidin-1-yl, piperidin-1-yl or hexahydroazepin-1-yl,
R₂, R₄, R₅ and R₇ independently are hydrogen, C₁-C₁₂alkyl, C₂-C₆hydroxyalkyl, C₃-C₁₂alkenyl, C₅-C₁₂cycloalkyl, C₆-C₁₈aryl, C₇-C₉ aralkyl or a group of formula II,
R₃ and R₆ independently are C₂-C₁₂alkylene, C₄-C₁₂iminodialkylene or oxadialkylene, C₅-C₁₂cycloalkylene, C₆-C₁₂arylene or C₇-C₁₂aralkylene,
R₈ is C₂-C₆alkylene,
Y is —O—R₉ or —NR₁₀R₁₁,
R₉ is hydrogen or C₁-C₁₈alkyl,
R₁₀ and R₁₁ are independently C₁-C6alkyl, 2,2,6,6-tetramethylpiperid-4-yl or 1 ,2,2,6,6-pentamethylpiperid-4-yl,
R₁₂ is hydrogen, oxyl, C₁-C₁₂alkyl, C₃-C₁₂alkenyl, C₇-C₉aralkyl, C₁-C₁₂acyl, 2,3-epoxypropyl or —CH₂CH(R₁₃)O—R₁₄,
or R₁₂ is C₁-C₁₂alkoxy, C₂-C₁₂alkenyloxy, C₅-C₁₂cycloalkoxy, C₅-C₈cycloalkenyloxy, C₆-C₁₈aryloxy, C₇-C₉aralkyloxy,
or R₁₂ is 2-hydroxy-2-methyl-propoxy or 2-hydroxycyclohexyloxy,
R₁₃ is hydrogen, methyl, ethyl or phenyl,
R₁₄ is hydrogen, C₁-C₁₂alkyl, C₃-C₁₂alkenyl, C₇-C₉aralkyl or C₁-C₁₂acyl,
R₁₅ is hydrogen, C₁-C₈alkoxy, C₃-C₈alkenyloxy or benzyloxy and
R₁₆ is defined as for R₁,
with the proviso that at least one of the groups R₁, R₂, R₄, R₅ and R₇ is a group of formula II.

9. A modified asphalt or bitumen composition according to claim 8 where the hindered amine compounds of formula I are incorporated in the asphalt or bitumen.

10. A modified asphalt or bitumen composition according to claim 8 whre the hindered amine compounds of formula I are incorporated in the synthetic rubber.

11. A modified asphalt or bitumen composition according to claim 8 where the synthetic rubber is a styrene-butadiene rubber.

12. A process for the stabilization of asphalt or bitumen against the deleterious effects of heat, light and oxygen, which process comprises
incorporating into asphalt or bitumen an effective stabilizng amount of one or more sterically hindered amine compounds of formula I according to claim 1.
